(19) United States
(12) Patent Application Publication
(10) Pub. No.: US 2020/0270734 A1
(43) Pub. Date: Aug. 27, 2020

(54) METHOD AND DEVICE FOR INSTALLING A WIRE GUIDE ON A TORCH HEAD FOR A COATING SYSTEM

(71) Applicant: GROB-WERKE GmbH & Co. KG, Mindelheim (DE)

(72) Inventors: Matthias SCHWEIGER, Mauerstetten (DE); Dineshbhai Parth PANDYA, Augsburg (DE); Maximilian DROPMANN, Kaufbeuren (DE); Heribert SAULE, Langenneufnach (DE); Stephan FREIDING, Hawangen (DE); Andreas HÄMMERLE, Schwabmünchen (DE); Uwe-Jens KRAUSE, Apfeltrach (DE)

(73) Assignee: GROB-WERKE GmbH & Co. KG, Mindelheim (DE)

(21) Appl. No.: 16/755,366

(22) PCT Filed: Oct. 17, 2018
(86) PCT No.: PCT/EP2018/078380

§ 371 Date: Apr. 10, 2020

(30) Foreign Application Priority Data
Oct. 18, 2017 (DE) 10 2017 124 303.8

(51) Int. Cl. C23C 4/131; G01B 11/00; G01B 11/24; G06T 7/73; G06T 7/00; G06T 7/13

(52) U.S. Cl. CPC C23C 4/131; G01B 11/002; G01B 11/24; G06T 2207/30108; G06T 7/0004; G06T 7/13; G06T 7/73

(57) ABSTRACT

A method and a device are provided for installing a wire guide on a torch head, which is used in a coating system that applies thermal coatings, in a positionally accurate manner while also simplifying and making reproducible the adjustment of the position of the wire guide, thereby reducing the work effort that is needed for this purpose. In particular, by subjecting an image that includes at least portions of the wire guide and a portion of the torch head to image processing, the positions of the respective components are calculated and displayed in real time on a display unit for use by a person installing the wire guide on the torch head.

### CROSS-REFERENCE

This application is the US national stage of International Patent Application No. PCT/EP2018/078380 filed on Oct. 17, 2018, which claims priority to German Patent Application 10 2017 124 303.8 filed on Oct. 18, 2017.

### TECHNICAL FIELD

The present disclosure generally relates to a method and a device for installing a wire guide on a torch head for use in a coating system that applies a thermal coating, e.g., onto a cylinder of a vehicle cylinder block. Such a method or such a device is preferably used while servicing the torch head to install the wire guide in a positionally accurate manner.

### BACKGROUND ART

For example, cylinder blocks (engine blocks) are typically manufactured as a cast component. The inner surfaces of cylinders are directly manufactured in the casting process and usually do not fulfill (satisfy) geometric requirements and/or the requirements, with respect to the surface properties, placed on a cylinder bore, on or in which a piston will slide during operation of the internal combustion engine, especially in case the cast component is made of aluminum or another light metal.

For this reason, either cylinder liners, whose inner surfaces already correspond to the requirements or are appropriately processed after insertion, are inserted into the cylinders, or coatings are applied onto the inner surfaces of the cylinders. Such coatings may be applied, for example, using a thermally sprayed coating.

One known method for thermal coating is, for example, the so-called RSW method (here RSW stands for “Rotating Single Wire”), wherein one end of an automatically-supplied wire forms an anode, an electric arc emanating from a cathode impinges on the end of the wire, which converts a gas or gas mixture into the plasma state that melts the end of the wire when impinging on the wire. The melted wire material is then atomized by a transport gas mixture and accelerated toward the cylinder bore to be coated. The metal particles entrained in the transport gas mixture are thus applied onto the cylinder bore (with the particles undergoing deformation upon hitting the surface of the cylinder bore) and form the coating. In order to ensure the desired operating properties of the spray beam, an accurate positioning of a wire guide for the anode wire in relation to the other components of the torch head, in particular to the cathode, is necessary.

### SUMMARY OF THE INVENTION

It is an object of the present teachings to facilitate a positionally accurate installation of the wire guide (which guides the anode wire) on the torch head that is as simple and reproducible as possible, in order to thereby reduce the time required for maintenance of the torch head, in which the wire guide is removed and replaced if necessary.

In some embodiments of the present teachings, an image, which shows (includes) at least one portion of the torch head and at least one portion of the wire guide (which guides the anode wire) positioned on the torch head is captured and processed to identify at least one first feature of the wire guide and at least one second feature of the portion of the torch head, using which the respective positions of the components in the image can be determined. Therefore, the position of the wire guide in relation to the torch head can be automatically determined by suitable image-processing methods, and in particular displayed in real time for a technician who is installing the wire guide on the torch head. The technician can thus easily discern the current position of the wire guide by referring to the display and adjust it to the desired position without a problem. In such an embodiment, it is not necessary that the technician has specific experience with respect to the correct adjustment of the wire guide. In particular, it is usually not necessary to readjust the wire guide, potentially multiple times, in the installed state of the torch head in the coating system. Instead of or in addition to displaying the position, it can be, for example, optically and/or visually output to the technician whether or not the relative position of the wire guide is correct. In addition, instructions for correcting the position can optionally also be displayed.

In some embodiments of the present teachings, the features that are to be captured using the image capture device, or based on which the determination of the positions is effected, are appropriately selected, thereby ensuring a reliable identification thereof as well as a high reproducibility. In particular, features such as edges or contours of components are preferably selected that are installed in a definite manner and preferably undergo no or only slight wear during operation of the torch head. In addition, the features are preferably selected such that they lie in a smallest-possible image section so that a maximum accuracy can be achieved in the positioning.

In order to ensure that the features can be reliably recognized by the image capture device, it is preferred that the regions of the wire guide and/or of the torch head having the respective features are illuminated in a suitable manner. Therefore, in some embodiments of the present teachings, the illumination of a feature is selected depending on, for example, the materials, the geometry, and the surface properties of the respective components and/or relative positions of the image capture device, the illumination, and the feature. When properly illuminated, the corresponding edges or contours can be reliably detected by the image capture device. Here in particular, a matching of the image capture device with the respective illumination units is required so that the light emitted is preferably only reflected or reflected as little as possible from the surfaces of the components provided for this purpose into the objective of the image capture device. Thus, for example, a spotlight that is disposed at a predetermined angle with respect to the torch head is well suited to identify the edges of the wire guide as reliably as possible.

In some embodiments of the present teachings, the image capture device is disposed with respect to the torch head in a predetermined spatial relationship. As a result, high reproducibility and furthermore a shortening of the time required for installation can be achieved. In such embodiments, the image capture device need not be positioned again each time in relation to the torch head when another torch head will be serviced. In particular, if the entire torch head is mounted on an installation device such that the torch head has the predetermined spatial relationship with respect to the image capture device and the illumination units, it is not necessary to always realign the camera and the illumination units with the torch head in order to be able to capture the desired image section and be able to reliably discern the respective features of the components. Moreover, during the installation of the wire guide on the torch head (that is attached to the installation device provided specifically for this purpose), the coating system can continue to be operated with a different torch head. In this way, stoppage time of the coating system can be minimized.

In some embodiments of the present teachings, a plurality of images is captured at a predetermined frequency and an averaging of the positions is determined based on the plurality of images, for example, of the wire guide. In such an embodiment, precision and reliability with regard to the position-determination can be increased based on the image sections captured by the image capture device.

Exemplary embodiments and further developments of the invention are described below with reference to the Figures.

### BRIEF DESCRIPTION OF THE DRAWINGS

FIG. 1 shows a schematic side view of a torch head attached to an installation device according to the present teachings.

FIG. 2 shows a plan view of the installation device having the torch head.

FIG. 3 shows an image, captured by an image capture device, of a portion of the torch head having a wire guide positioned thereon.

### DETAILED DESCRIPTION OF THE INVENTION

The method described below and the device described below according to one embodiment of the present teachings are intended for the installation of a wire guide on a torch head for a coating system in a positionally accurate manner, in particular when using the RSW method to coat surfaces.

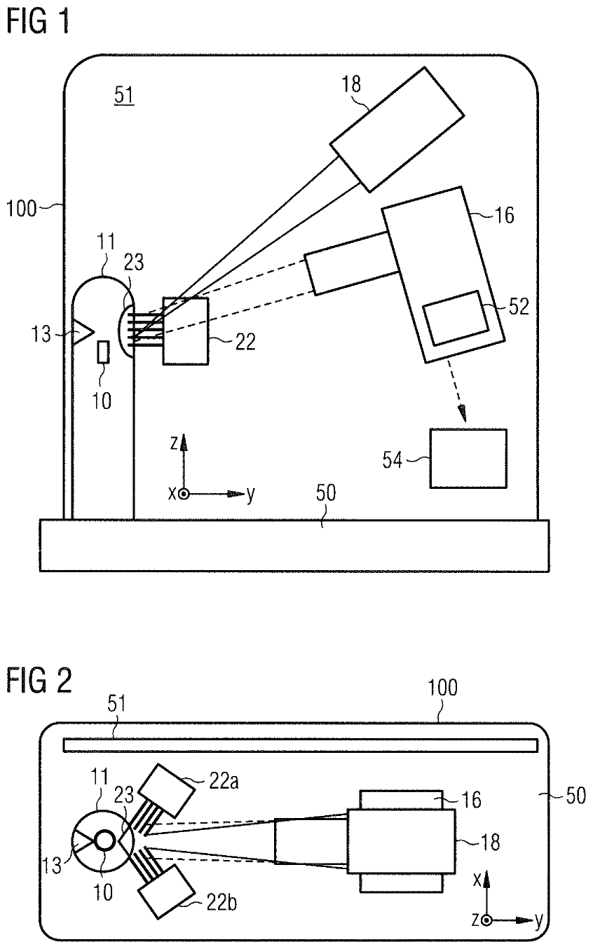

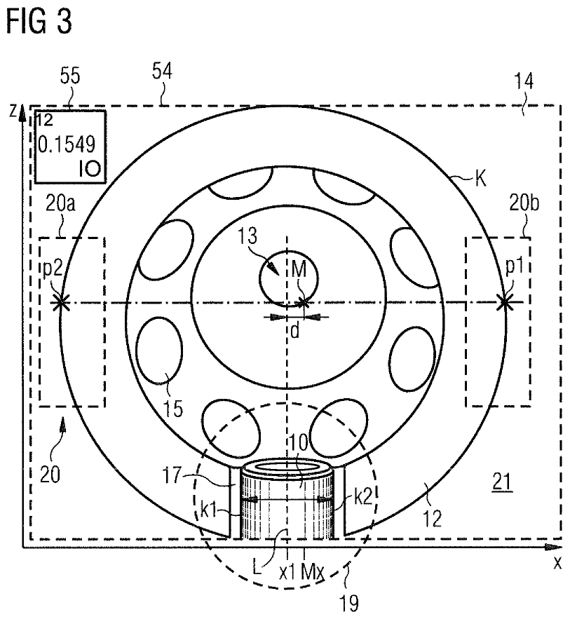

FIG. 1 shows an embodiment of an installation device 100 for installing a wire guide 10 on a torch head 11 for a coating system for thermal coating. As shown in FIG. 1, the torch head 11 has, for example, an essentially cylindrical shape, with a housing, into which a cathode 13 is screwed on one end. On the side opposite the cathode 13, the housing of the torch head 11 has a nozzle opening 23. Gases needed for the coating process to be carried out by the torch head are transported via ducts in the interior of the housing. In particular, a gas or gas mixture is guided past the cathode 13 and subsequently converted into the plasma state. Furthermore, a transport gas is supplied by a plurality of supply channels 15 via a transport gas nozzle 12, which is shown in more detail in FIG. 3, toward the nozzle opening 23.

The wire, which forms the anode, is advanced in the region between the cathode 13 and the nozzle opening 23 of the torch head 11 via (through) the wire guide 10, which is shown in more detail in FIG. 3. As shown in FIG. 3, the transport gas nozzle 12 has a recess 17, in which the wire guide 10 is disposed. The wire guide 10 is configured, in essence, as a tube extending in the longitudinal direction of the torch head 11.

In order to exchange (replace) the wire guide 10 or otherwise service the torch head 11, the torch head 11 is mounted on the installation device 100 such that it is positioned at least substantially vertically thereto. In this orientation, the cathode 13 and the transport gas nozzle 12 are located at the upper end of the torch head 11. For example, the torch head 11 is screw fastened with (onto) the installation device 100, for example, via a not-shown adapter piece, which is disposed on a base plate (support) 50 of the installation device 100 and has a geometry that corresponds to the connection of the torch head 11 to an associated lance in the coating system. In addition to the base plate 50, the installation device 100 includes a mount 51, e.g., a plate that is attached to and extends at least substantially vertically with respect to the base plate 50, an image capture device 16, which is attached to the mount 51, and an illumination system including a first light source 18 and a second light source 22 that are also attached to the mount 51. The image capture device 16 is attached to the installation device 100 such that it has a predetermined spatial relationship with respect to the torch head 11 attached to the installation device 100. In particular, the image capture device 16, which can be configured, for example, as a camera such as an intelligent camera (smart camera), is attached to the mount 51 such that the image captured by the camera shows (includes) the transport gas nozzle 12 of the torch head 11 and the wire guide 10. The first and the second light sources 18, 22 are also attached to the installation device 100 such that they have a predetermined spatial relationship with respect to the torch head 11, and in particular illuminate the region of the torch head 11 having the transport gas nozzle 12 and the wire guide 10, which is described in more detail below.

The installation device 100 further includes a processing unit 52 that is adapted to process an image 14 (see FIG. 3) captured by the image capture device 16. As shown in FIG. 1, in some embodiments the processing unit 52 can be integrated into the image capture device 16, i.e., the image capture device 16 can be configured as the above-mentioned smart camera. The image 14 captured by the image capture device 16 is displayed on a display unit 54, which can also be adapted to display a result of the processing by the processing unit 52. It is understood that, in other embodiments, the processing unit 52 can be provided separate from the image capture device 16, for example, as a component of an external computing system, which is connected to the image capture device 16 via a suitable interface. Furthermore, the display unit 54 can be configured as any suitable device for displaying the image captured by the image capture device 16, for example, as a screen of a computer system connected to the image capture device 16. In other embodiments the display unit 54 can also be integrated into the image capture device 16, i.e., the image capture device 16 can also include a display on which the captured image and optionally the result of the processing can be displayed owing to the processing unit 52.

As shown in FIG. 1, the image capture device 16 of the exemplary embodiment is attached to the installation device 100 such that it looks into the nozzle opening 23 obliquely from above. The corresponding captured image 14 is shown in FIG. 3. In some exemplary embodiments, the image capture device 16, the first light source 18, and the torch head 11 attached at a fixed position can lie, at least substantially, in one plane (plane Y-Z in FIGS. 1 and 2), wherein the image capture device 16 (the central image beam) is attached to the installation device 100 at a first predetermined angle, for example, between 5° and 25°, preferably 9° to 13°, with respect to the horizontal. The first light source 18, which can be configured, for example, as a spotlight, is attached to the installation device 100 such that it is attached to the installation device 100 at a second predetermined angle, for example, between 30° and 80°, preferably 45° to 50°, more preferably 47° to 48°, with respect to the horizontal, or light radiates at the specified angles with respect to the horizontal. In the specified orientation it is ensured that the light from the first light source 18, which is reflected by the wire guide 10, arrives at the objective of the image capture device 16 and the features explained below, in particular of the wire guide 10, can be recognized in the image 14 captured by the image capture device 16. Preferably, the operating distance of the image capture device 16 is approximately 90 to 105 mm. The image capture device 16 can, for example, have a resolution of 5 megapixels, which results in a pixel size of approximately 5 μm.

The operating distance of the first light source 18 (the spotlight) is between 200 and 300 mm, for example, approximately 260 mm. At this distance, the spot at the position of the wire guide 10 is the smallest and most intense. However, it is understood that the operating distance can vary depending on the configuration of the spotlight. The light emitted by the first light source 18 can be in a wavelength range between 350 and 850 mm.

As shown in FIGS. 1 and 2, the second light source 22 comprises two light sources 22a, 22b that, with respect to the (vertical) plane in which the image capture device 16, the first light source 18 and the torch head 11 lie, are provided symmetrically on both sides of this plane. Here the two light sources 22a, 22b are preferably provided approximately at the same height as the nozzle opening 23 in order to illuminate it, and are preferably disposed at an angle between 45° and 75°, preferably 55° to 60°, with respect to the plane. The light sources 22a, 22b are spaced apart from the region to be illuminated, for example, between 20 and 100 mm, more preferably between 30 and 60 mm.

As shown in FIG. 3, the first light source 18 illuminates a first region 19, in which the wire guide 10 is contained, of the torch head 11. The two second light sources 22a, 22b illuminate a second region 20 of the torch head 11, in particular two partial regions 20a and 20b on sides opposing each other in relation to the transport gas nozzle 12. The second light sources 22a, 22b can be, for example, area light sources that can emit light in the infrared range and/or can be driven in a pulsed manner. This serves to protect the operator of the installation device, so that the operator is not affected by reflections in the visible range.

The method for installing and/or positioning of the wire guide 10 on the torch head 11 according to the present embodiment will now be explained in more detail below with reference to FIGS. 1 to 3.

In a first step the torch head 11 is attached to the installation device 100 at a predetermined position. As already explained above, the torch head 11 can be screw-fastened on the installation device 100 for this purpose, optionally using a suitable adapter piece.

After the torch head 11 has been mounted on the installation device 100, the torch head 11 is located at a predetermined installation position. In particular, the nozzle opening 23 or the transport gas nozzle 12 is located at a fixed position, so that the image capture device 16 attached to the installation device 100, and the first light source 18 and the second light sources 22a, 22b respectively have predetermined spatial relationships with respect to the transport gas nozzle 12 and the wire guide 10. In this state, the image capture device 16 can capture the previously selected image section, in which in particular the transport gas nozzle 12 and the wire guide 10 to be positioned with respect thereto are contained. The captured image 14 is shown in FIG. 3 and is displayed on the display unit 54 as a stationary image or as a live stream. As shown in FIG. 3, the image 14 shows (includes) at least one portion of the torch head 11 and at least one portion of the wire guide 10 positioned on the torch head 11. In the present embodiment, the at least one portion of the torch head 11 comprises the transport gas nozzle 12 and/or the edge region thereof. Furthermore, as shown in FIG. 3, the wire guide 10 provided in the recess 17 can be seen.

The processing unit 52 is adapted (e.g., programmed) to process the image 14 captured by the image capture device 16 in order to identify a first feature of the wire guide 10 (the position x1 of the wire guide 10 on an axis X (in a first direction X) in the image 14 can be determined using the first feature) and at least one second feature of the transport gas nozzle 12 (a reference position M of the transport gas nozzle 12 can be determined in the image 14 using the at least one second feature). In the present embodiment, the wire guide 10 is to be adjusted or shifted in the direction of the axis X in order to accurately position the wire guide relative to the recess 17 and the cathode 13. In particular, in the present embodiment the axis X (first direction X) is the direction perpendicular to the longitudinal direction of the wire guide 10 and perpendicular to the beam direction. Consequently, the processing unit 52 is in particular adapted (e.g., programmed) to determine: (i) the position x1 of the wire guide 10 on the axis X (in the first direction X) based on the identified first feature of the wire guide 10, and (ii) the reference position M of the transport gas nozzle 12 in the first direction X based on the at least one identified second feature. Based on these determinations (i.e. the position x1 and the reference position M), the processing unit 52 can then determine the distance d between the position x1 of the wire guide 10 on the axis X (in the first direction X) and a coordinate Mx of the reference position M on the axis X (in the first direction X). The determined distance d can then be displayed on the display unit 54. This is described below in more detail.

The feature of the wire guide 10 that is to be determined based on the image 14 comprises, for example, at least one edge k1 or k2 of the wire guide 10, which edge(s) extend(s) perpendicular to the axis X. For this purpose it is necessary that the contours (e.g., edges k1, k2) of the wire guide 10 can be delineated with as high contrast as possible. For this purpose, the above-mentioned spotlight is used, which is provided in accordance with the spatial relationship with respect to the image capture device 16, which was carefully determined based on the position of the image capture device 16. Furthermore, it is recommended to clean as much as possible the surface of the recess 17, in which the wire guide 10 is positioned, and keep it free of contaminants and deposit buildup in order to reflect the light as well as possible. In this way, the light of the first light source 18, which strikes the center of the cylindrical outer surface of the wire guide 10, reflects directly into the objective of the image capture device 16, whereas the wire guide 10 is always depicted in the image 14 darker toward the edges thereof, since light from the edge regions (k1, k2) of the wire guide 10 is not reflected into the objective of the image capture device 16. More particularly, there is nearly no reflection at the edges k1 and k2 of the wire guide 10. On the other hand, the surface of the recess 17 behind the wire guide 10 appears bright, since light is reflected by the surface of the recess 17 toward the image capture device 16. In this way, the edges k1 and k2 of the wire guide 10 can be depicted with high contrast in the image 14. The edges k1 and k2 and/or the X-coordinates thereof in the image 14 can be determined by suitable known image processing methods, for example, algorithms for edge detection, color recognition, etc. Thus, due to the symmetry of the wire guide 10, the coordinate x1 of the centerline (virtual centerline L) between the edges k1 and k2 on the axis X can also be calculated. The current position x1 of the wire guide 10 along the axis X results from this calculation.

In a similar manner, the periphery of the transport gas nozzle 12 is illuminated by the second light source 22 on opposite sides in the direction of the axis X. Due, for example, to different surface roughnesses of the transport nozzle 12 and of the nozzle ring 21 of the nozzle opening 23, which nozzle ring 21 lies outside the transport nozzle 12, and/or due to the different arrangement angle of the respective surface region, it is noted that reflections of different strengths also occur here, so that sufficient contrast between the transport gas nozzle 12 and the nozzle ring 21 is achieved in the image 14. Thus, as shown in FIG. 3, an essentially circular contour K, which represents the outer circumferential edge of the transport nozzle 12, is obtained. This contour K, as shown in FIG. 3, exhibits a symmetry with respect to an axis Z that is perpendicular to the axis X. Therefore, the reference position M, i.e., the position of the centerline or of the center point of the transport gas nozzle 12 on the axis X, can be determined based on this contour K. For example, two points p1 and p2 on opposite sides of the transport gas nozzle 21 (in particular, two points p1 and p2 that lie on the contour K and have the same coordinate on the axis Z) can be determined. Then, the X coordinate Mx of the reference position M on the axis X can be determined by determining the X coordinates of the points p1 and p2.

By comparing the coordinates of the centerline of the wire guide 10 and of the centerline or of the centerpoint of the transport gas nozzle 12, a distance (d=Mx−x1) between them can be calculated. Using this distance d, it is possible to determine the deviation of the position of the wire guide 10 from the desired position, at which the centerline thereof, in essence, has a predetermined distance (target distance) to the centerline or the centerpoint of the transport gas nozzle 12 (the center of the nozzle opening 23), or the deviation from the predetermined distance is smaller than a predetermined threshold value. Here the predetermined distance can be positive or negative and can be suitably determined in advance for each torch head or each transport gas nozzle. In some cases, the predetermined distance can be equal to zero. The respective target distances can be associated with the corresponding torch heads and, for example, stored in a storage that the processing unit 52 can access. A selection of the target distance associated with a currently installed torch head can be made by a technician, or automatically, for example, by capturing a suitable identifier of the torch head.

The distanced calculated in the manner specified above (e.g., 0.1549) can be displayed on the display unit 54 in a display region 55 of the image 14. Based, for example, on the resolution of the image 14 and the distance of the image capture device from the nozzle opening 23, the processing unit 52 is adapted here to convert the distances obtained in pixels into linear measures (e.g., μm) and to display them. Taking this notification into account, the technician can now set the wire guide 10 to the desired position in the direction of the axis X using the installation system provided for this purpose, in particular by using a screw system having fine-pitch threads together with a specially designed tool for moving the wire guide 10 in the X direction. Owing to the display on the display unit 54, the technician can thus track the current position of the wire guide 10, preferably in real time. As soon as the displayed distance d corresponds to the target distance, or the deviation therefrom is smaller than the predetermined threshold value or is essentially zero in accordance with the display precision, the positionally accurate installation of the wire guide 10 is completed.

To increase the reliability of the processing and/or determining of the position of the wire guide 10, a predetermined number of images (e.g., 10 to 30 images, in particular 15 images) may be captured by the image capture device at a predetermined frequency, for example, 1 to 60 Hz, preferably 1 to 30 Hz, in particular 2 Hz, and processed by the processing unit 52. The above-specified features and/or positions can be determined for each captured image. The determined positions can then be averaged and displayed on the display unit 54 as averaged positions. For example, the current number of the measurements or images taken can be displayed on the display region 55 (in the example of FIG. 3, image no. 12 is currently being displayed). It can also be displayed in the display region 55 as to whether a successful recognition of the features could be performed (IO in the present case of a recognition), e.g., in case a successful recognition has taken place for a certain number of measurements of a measurement series. In this way it is possible to prevent the technician from relying upon individual incorrect measurements or recognitions to set the wire guide 10 at an incorrect position.

After completion of the setting of the position of the wire guide 10, the torch head 11 can be removed from the installation device 100 and reinstalled in the coating system. The wire guide 10 is thereby already located at the desired position, so that the required quality of the coating achieved by using the torch head can be ensured without, for example, a readjustment having to be made when the torch head is installed in the coating system.

A customized measurement strategy is provided by the above-described method and/or by the above-described device. Here the features that are required for the determination of the position of the wire guide 10 or of the reference position M are stipulated on edges of components, which are mounted in a definite manner on the torch head 11 and ideally undergo no wear. This leads to a high reliability and reproducibility of the installation of the wire guide 10 in the torch head 11. The light sources and their positions are also suitably selected in order to be able to capture and display the to-be-illuminated features with a highest-possible contrast. In this regard, the type of illumination is preferably selected in accordance with the materials, the geometry, and the surface properties of the respective components.

In order that the features can be reliably recognized, in particular in the case of curved surfaces like those of the wire guide 10, it is necessary to precisely match the light sources and the image capture device to each other. Thus, for example, the light source 18 that illuminates the wire guide 10 must be particularly precisely aligned with respect to the torch head 11.

Although the present invention was described with regard to the positionally precise installation of a wire guide on a torch head of a coating system, it is understood that the methods disclosed herein can be used generally for a positionally accurate installation of a first component on a second component. That is, instead of the wire guide 10 and the transport gas nozzle 12, at least one part of the second component and at least one part of the first component positioned on the second component can be captured by an image capture device. In this case, the second component can again be attached to a mounting device such that it has a predetermined spatial relationship with respect to the image capture device. Suitable features (e.g., edges or the like) of the respective components or of regions thereof can likewise be selected. Based on these features, the positions of the respective components or of regions thereof can be determined in the manner described herein. One or more light sources can also optionally be provided in order to make possible or to improve the recognition (identification) of the respective features.

Although the edges of the transport gas nozzle 12 were used for determining the reference position M in the preceding description, it is understood that in other exemplary embodiments, other components or regions of the torch head 11 can be used in order to determine the reference position M. A modification of the second light source 22 and/or of the image capture device 16 is then possibly required. Furthermore, when using a component that has a circular contour K, it is also provided that a centerpoint thereof is determined as the reference position M based on, for example, three points of the contour K. Then the distance d of the centerpoint of the contour K to the centerline of the wire guide 10 can also be determined.

It is also understood that, in case a component other than the wire guide 10 is to be positioned, e.g., a component that does not have a cylindrical shape, a central line of the component need not necessarily be determined, but rather a centerpoint of, for example, a circular or other contour, can also be determined as the position of the component on the axis X.

In addition, in other applications of the present teachings, instead of the one-dimensional positioning in the above-described embodiment, a two-dimensional positioning can also be carried out, e.g., by determining suitable features that indicate a position of a point of a component to be positioned with respect to a reference point on another component. The calculations required for this purpose must then be adapted accordingly.

It is explicitly emphasized that all of the features disclosed in the description and/or the claims should be considered as separate and independent from one another for the purpose of the original disclosure as well as for the purpose of limiting the claimed invention, independent of the combinations of features in the embodiments and/or the claims. It is explicitly stated that all range specifications or specifications of groups of units disclose every possible intermediate value or subgroup of units for the purpose of the original disclosure as well as for the purpose of limiting the claimed invention, in particular also as the limit of a range specification.

### Aspects

A1. Method for the positionally accurate installation of a first component (10) on a second component (12), including the following steps:
by using an image capture device (16) that has a predefined spatial relationship with respect to the second component (12), capturing an image (14) that shows at least one portion of the second component (12) and at least one portion of the first component (10) positioned on the second component (12);
processing the image (14) to identify at least one first feature of the first component (10), based on which first feature a position (x1) of the first component on an axis (X) in the image (14) can be determined, and at least one second feature of the second component (12), based on which a reference position (M) of the second component (12) in the image (14) can be determined;
determining the position (x1) of the first component (10) based on the at least one identified first feature;
determining the reference position (M) of the second component (12) based on the at least one identified second component; and
moving the first component (10) along the axis (X) until the position (x1) of the first component has a predetermined positional relationship with respect to the reference position (M) of the second component (12).

A2. Method according to Aspect A1, wherein the predetermined positional relationship consists in that the position (x1) of the first component (10) on the axis (X) has a predetermined distance (d) with respect to a coordinate (Mx) of the reference position (M) on the axis (X), in particular a distance (d) that is smaller than a predetermined threshold value, or coincides therewith.

A3. Method according to Aspect A1 or A2, further including:
illuminating at least one first region (19) of the first component (10) having the first feature, and illuminating at least one second region (20) of the second component (12) having the second feature.

A4. Method according to Aspect A3, wherein the illumination of the at least one first region (19) is effected by a first light source (18), and the illumination of the at least one second region (20) is effected by a second light source (22), wherein the first light source (18) and/or the second light source (22) has (have) a predetermined spatial relationship with respect to the second component (12).

A5. Method according to one of Aspects A1 to A4, further including:
providing an installation device (100) on which at least the image capture device (16) is attached;
attaching the second component (12) to the installation device (100) such that the image capture device (16) has the predetermined spatial relationship with respect to the second component (12).

A6. Method according to Aspects A4 and A5, wherein the first light source (18) and/or the second light source (22) are or is attached to the installation device (100) such that they or it have or has the predetermined spatial relationship with respect to the second component (12) attached to the installation device (100).

A7. Method according to one of Aspects A1 to A6, wherein the first feature comprises at least one edge (k1) of the first component (10), which edge (k1) extends perpendicular to the axis (X).

A8. Method according to Aspect A7, further including:
identifying a first edge (k1) and a second edge (k2) of the first component (10), which first edge (k1) and second edge (k2) both extend perpendicular to the axis (X); and
calculating a virtual centerline (L) with respect to the first edge (k1) and the second edge (k2), wherein the coordinate of the virtual centerline (L) indicates the position (x1) of the first component (10) on the axis (X).

A9. Method according to one of Aspects A1 to A8, wherein the second feature comprises a circular contour (K) of the second component (12), wherein the centerpoint of the contour (K) specifies the reference position (M).

A10. Method according to Aspect A9, further including:
illuminating two mutually opposite regions (20a, 20b) of the contour (K) using two light sources (22a, 22b);
identifying at least three points (p1, p2, p3) of the contour (K), wherein at least one of the three points (p1, p2, p3) lies in a different region (20a, 20b) than at least one other of the points (p1, p2, p3); and
calculating the centerpoint based on the at least three points (p1, p2, p3).

A11. Method according to Aspect A4 or A10, wherein the second light source (22) or the at least two light sources (22a, 22b) emit(s) light in the infrared range and/or is/are operated in a pulsed manner.

A12. Method according to one of Aspects A1 to A11, further including:
selecting the at least one first feature and the at least one second feature as edges (k1, k2, K) of the first component (10) and/or of the second component (12), which components have definite positions and ideally undergo no wear;
selecting suitable illuminations for the at least one first feature and the at least one second feature depending on (in accordance with) the material, the geometry, and/or the surface properties of the first component (10) and of the second component (12); and
determining the spatial relationship between the image capture device (16), the second component (12), and the illuminations such that the first feature and the second feature can be identified in the image (14) captured by the image capture device (16).

A13. Method according to one of Aspects A1 to A12, further including:
capturing a predetermined number of images (14) at a predetermined frequency, for example, 1 to 60 Hz, preferably 2 to 30 Hz;
determining the position (x1) of the first component (10) and/or the reference position (M) of the second component (12) for each captured image;
averaging the determined positions; and
displaying the averaged positions on a display unit (54).

A14. Method according to one of Aspects A1 to A13, wherein the first component (10) is a wire guide that is to be installed in a positionally accurate manner on a torch head (11) for a coating system for thermal coating, which torch head (11) includes the second component (12), which may be a transport gas nozzle of the torch head.

A15. Installation device (100) for installing a wire guide (10) on a torch head (11) for a coating system for thermal coating, including:
a support (50) on which the torch head (11) is affixable at a defined position;
an image capture device (16) that is attached to the installation device (100) such that it has a predetermined spatial relationship with respect to the torch head (11) attached at the defined position;
a processing unit (52) that is adapted to process an image (14) captured by the image capture device (16); and
a display unit (54) that is adapted to display a result of the processing by the processing unit (52),
wherein:
the image capture device (16) is adapted to capture an image (14) that shows at least one portion of the wire guide (10) positioned on the torch head (11) and shows at least one portion of a predetermined component or region (12) of the torch head (11),
the processing unit (52) is adapted to:
process the image (14) to identify at least one first feature of the wire guide (10), based on which first feature a position (x1) of the wire guide (10) on an axis (X) in the image (14) can be determined, and at least one second feature of the predetermined component or region (12), based on which second feature a reference position (M) of the predetermined component or region (12) in the image (14) can be determined;
determine the position (x1) of the wire guide (10) based on the at least one identified first feature;
determine the reference position (M) of the predetermined component or region (12) based on the at least one identified second feature; and
determine a distance (d) between the position (x1) of the wire guide (10) on the axis (X) and a coordinate (Mx) of the reference position (M) on the axis (X), and
wherein the display unit is adapted to display the distance (d).

A16. Installation device according to Aspect A15, further including:
at least one light source (18, 22) that is configured to illuminate at least one first region (19) of the wire guide (10) having the first feature, and at least one second region (20) of the predetermined component or region (12) of the torch head (11) having the second feature,
wherein the at least one light source (18, 22) is attached to the installation device (100) such that it has a predetermined spatial relationship with respect to the torch head (11) attached at the defined position.

A17. Installation device according to Aspect A16, wherein
the at least one light source (18, 22) includes a first light source (18), preferably a spotlight source, which is configured to illuminate at least the first region (19), and a second light source (22), preferably an area illumination light source, which is configured to illuminate at least the second region (20),
the image capture device (16), the first light source (18), and the torch head (11) attached at the defined position lie, in essence, in a plane, wherein the image capture device (16) is attached to the installation device (100) at a first predetermined angle, for example, between 5° and 25°, preferably 9° to 13°, with respect to the horizontal, and the first light source (18) is attached to the installation device (100) at a second predetermined angle, for example, between 30° and 80°, preferably 45° to 50°, with respect to the horizontal, and
the second light source (22) includes two light sources (22a, 22b) that are provided on both sides of the plane symmetrically with respect to the plane, preferably at the same height as the predetermined component or region (12), and at a respective angle between 45° and 75°, preferably 55° to 60°, with respect to the plane.

A18. Installation device according to Aspect A17, wherein the second light source (22) emits light in the infrared range and/or is operated in a pulsed manner.

A19. Installation device according to one of the Aspects A15 to A18, wherein:
the determination of the position (x1) of the wire guide (10) by the processing unit (52) includes:
   identifying a first edge (k1) and a second edge (k2) of the wire guide (10), which first edge (k1) and second edge (k2) both extend perpendicular to the axis (X); and
   calculating a virtual centerline (L) with respect to the first edge (k1) and the second edge (k2), wherein the coordinate of the virtual centerline (L) indicates the position (x1) of the wire guide (10) on the axis (X), and
the determination of the reference position (M) of the predetermined component or region (12) by the processing unit (52) includes:
   identifying a circular contour (K) of the predetermined component or region (12), wherein the centerpoint of the contour (K) specifies the reference position (M).

### REFERENCE NUMBER LIST

11 Torch head
12 Transport gas nozzle
13 Cathode
14 Image
15 Supply channel
16 Image capture device
17 Recess
18 First light source
19 First region
20 Second region
20a, 20b Second regions
21 Nozzle ring
22 Second light source
22a, 22b Second light sources
23 Nozzle opening
50 Base plate
51 Mount
52 Processing unit
54 Display unit
55 Display region
100 Installation device

1. A method for installing a wire guide on a torch head for a coating system for thermal coating in a positionally accurate manner, including:
using an image capture device that is disposed in a first predetermined spatial relationship with respect to the torch head to capture an image that includes at least one portion of the torch head and at least one portion of the wire guide positioned on the torch head;
processing the image to identify at least one first feature of the wire guide, wherein a position (x1) of the wire guide on a first axis (X) in the image can be determined based on the at least one first feature, and to identify at least one second feature of the portion of the torch head, wherein a reference position (M) of the portion of the torch head in the image can be determined based on the at least one second feature;
determining the position (x1) of the wire guide based on the at least one identified first feature;
determining the reference position (M) of the portion of the torch head based on the at least one identified second feature; and
moving the wire guide along the first axis (X) until the position (x1) of the wire guide is disposed in a predetermined positional relationship with respect to the reference position (M) of the portion of the torch head.

2. The method according to claim 1, wherein the predetermined positional relationship is set such that the position (x1) of the wire guide on the first axis (X) is spaced apart from a coordinate (Mx) of the reference position (M) on the first axis (X) by a predetermined distance (d), in particular having a deviation that is smaller than a predetermined threshold value, or coincides therewith.

3. The method according to claim 1, further including:
using a first light source to illuminate at least one first region of the wire guide that includes the first feature; and
using a second light source to illuminate at least one second region of the portion of the torch head that includes the second feature,
wherein the first light source has a second predetermined spatial relationship with respect to the torch head and the second light source has a third predetermined spatial relationship with respect to the torch head.

4. The method according to claim 1, further including:
attaching the torch head to an installation device that has the image capture device already attached thereto such that the image capture device and the torch head are disposed in the first predetermined spatial relationship.

5. The method according to claim 1, further including:
identifying a first edge and a second edge of the wire guide in the image, the first edge and the second edge both extending perpendicular to the first axis (X); and
calculating a virtual centerline (L) of the wire guide based on the identified first edge and the identified second edge,
wherein:
the first feature comprises at least one of the first edge and the second edge of the wire guide, and
the coordinate of the centerline (L) on the first axis (X) indicates the position (x1) of the wire guide on the first axis (X).

6. The method according to claim 1, wherein:
the second feature comprises a contour (K) of the portion of the torch head
the contour (K) is symmetrical with respect to a second axis (Z) that is perpendicular to the first axis (X), and
the reference position (M) is defined by the symmetry of the contour (K) with respect to the second axis.

7. The method according to claim 6, further including:
illuminating a first region of the contour (K) and a second region of the contour (K) using at least two light sources, the second region of the contour (K) being opposite of the first region of the contour (K);
identifying at least two points (p1, p2) of the contour (K), wherein at least one of the at least two points (p1, p2) lies in a different one of the first and second regions than at least one other of the at least two points (p1, p2); and
calculating the reference position (M) based on the at least two points (p1, p2).

8. The method according to claim 7, wherein the at least two light sources emit light in the infrared range and/or are operated in a pulsed manner.

9. The method according to claim 1, further including:
capturing a predetermined number of images at a predetermined frequency;
determining the position (x1) of the wire guide and/or the reference position (M) of the portion of the torch head in each of the captured images;
averaging the determined positions; and
displaying the averaged positions on a display unit.

10. The method according to claim 1, wherein the portion of the torch head includes a transport gas nozzle of the torch head.

11. An installation device for installing a wire guide on a torch head for a coating system for thermal coating, including:
a support configured to detachably affix the torch head at a defined position on the support;
an image capture device attached to the installation device such that the image capture device is disposed in a first predetermined spatial relationship with respect to the torch head attached at the defined position, the image capture device being configured to capture at least one image that includes at least one portion of the wire guide positioned on the torch head and at least one portion of a predetermined component or region of the torch head;
a processing unit configured to process the at least one image captured by the image capture device; and
a display unit configured to display a result of the processing by the processing unit,
wherein
the processing unit is configured to:
process the at least one image to identify at least one first feature of the wire guide, wherein a position (x1) of the wire guide on a first axis (X) in the at least one image can be determined based on the first feature, and to identify at least one second feature of the predetermined component or region, wherein a reference position (M) of the predetermined component or region in the at least one image can be determined based on the second feature;
determine the position (x1) of the wire guide on the first axis (X) based on the at least one identified first feature;
determine the reference position (M) of the predetermined component or region based on the at least one identified second feature; and
determine a distance (d) between the position (x1) of the wire guide on the first axis (X) and a coordinate (Mx) of the reference position (M) on the first axis (X), and
wherein the display unit configured to display the determined distance (d).

12. The installation device according to claim 11, further including:
at least one light source configured to illuminate at least one first region of the wire guide having the first feature, and at least one second region of the predetermined component or region of the torch head having the second feature,
wherein the at least one light source is attached to the installation device such that the at least one light source has a second predetermined spatial relationship with respect to the torch head attached at the defined position.

13. The installation device according to claim 12, wherein:
the at least one light source includes a first light source configured to illuminate at least the first region, and two second light sources configured to illuminate at least the second region (20),
the image capture device, the first light source, and the torch head attached at the defined position lie, in essence, in a plane, wherein the image capture device is attached to the installation device at a first predetermined angle with respect to the horizontal, and the first light source is attached to the installation device at a second predetermined angle with respect to the horizontal, and
the two second light sources are provided on both sides of a vertical plane that is perpendicular to the horizontal so as to be symmetrical with respect to the vertical plane and are each disposed at an angle between 45° and 75° with respect to the vertical plane.

14. The installation device according to claim 13, wherein the two second light sources emit light in the infrared range and/or are driven in a pulsed manner.

15. The installation device according to claim 14, wherein:
the determination of the position (x1) of the wire guide by the processing unit includes:
identifying a first edge and a second edge of the wire guide, the first edge and the second edge both extending perpendicular to the first axis (X); and
calculating a virtual centerline (L) of the wire guide based on the first edge and the second edge, wherein the coordinate of the centerline (L) on the first axis (X) indicates the position (x1) of the wire guide on the first axis, and
the determination of the reference position (M) of the predetermined component or region by the processing unit includes:
identifying a contour (K) of the predetermined component or region that is symmetrical with respect to a second axis (Z) that is perpendicular to the first axis (X), the reference position (M) being defined by the symmetry of the contour (K) with respect to the second axis (Z).

16. The installation device according to claim 13, wherein:
the first light source comprises a spot light,
the second light sources each comprise an area illumination light source that is disposed at an angle between 55° and 60° with respect to the vertical plane,
the first predetermined angle is between 9° and 13°, and
the second predetermined angle is between 45° and 50°.

17. The method according to claim 7, further including:
attaching the torch head to an installation device that has the image capture device already attached thereto such that the image capture device and the torch head are disposed in the first predetermined spatial relationship;
using a first light source to illuminate at least one first region of the wire guide that includes the first feature;
using a second light source to illuminate at least one second region of the portion of the torch head that includes the second feature;
identifying a first edge and a second edge of the wire guide in the image, the first edge and the second edge both extending perpendicular to the first axis (X); and
calculating a virtual centerline (L) of the wire guide based on the identified first edge and the identified second edge;
wherein:
the first light source has a second predetermined spatial relationship with respect to the torch head and the second light source has a third predetermined spatial relationship with respect to the torch head;
the first feature comprises at least one of the first edge and the second edge of the wire guide, and
the coordinate of the centerline (L) on the first axis (X) indicates the position (x1) of the wire guide on the first axis (X).

18. A method for installing a wire guide on a torch head for a coating system that applies thermal coatings, including:
positioning an image capture device relative to the torch head in a first predetermined spatial relationship;
using the image capture device to capture a digital image that includes at least one portion of the torch head and at least one portion of the wire guide positioned on the torch head;
storing the digital image in a storage accessible by a processing unit;
in the processing unit, performing image processing on the digital image to identify at least one first feature of the wire guide and at least one second feature of the at least one portion of the torch head, determining a position (x1) of the wire guide in a first direction (X) based on the at least one identified first feature, and determining a reference position (M) of the at least one portion of the torch head in the first direction (X) based on the at least one identified second feature; and
moving the wire guide in the first direction (X) to position the wire guide in a predetermined positional relationship with respect to the reference position (M).

19. The method according to claim 18, further comprising:
displaying the position (x1) of the wire guide in the first direction (X) on a display unit.

20. The method according to claim 19, wherein the position (x1) of the wire guide in the first direction (X) is displayed on the display unit while the wire guide is being moved in the first direction (X) to position the wire guide in the predetermined positional relationship with respect to the reference position (M).
